(19) United States
(12) Patent Application Publication
(10) Pub. No.: US 2025/0314304 A1
(43) Pub. Date: Oct. 9, 2025

(54) One-Piece Internal Valve Components and Valves Including the Same

(71) Applicant: Crissair Inc., Valencia, CA (US)

(72) Inventors: Patrick Joseph LACANFORA, Moorpark, CA (US); Michela Joy VONFELDT, Valencia, CA (US)

(21) Appl. No.: 19/067,174

(22) Filed: Feb. 28, 2025

Related U.S. Application Data
(60) Provisional application No. 63/575,455, filed on Apr. 5, 2024.

(51) Int. Cl. F16K 1/36; F16K 25/00

(52) U.S. Cl. CPC F16K 1/36; F16K 25/005

(57) ABSTRACT

Disclosed herein are one-piece internal valve components that integrally include a combination of conventionally separate components (e.g., poppet (broadly, valve closure member), coil spring (broadly, biasing member), and retainer, etc.). The one-piece internal valve component has a unitary, monolithic, and/or single-piece construction. The one-piece internal valve components may be used in various valves, such as two-piece valves, check valves, relief valves, flow control valves for aircraft hydraulic systems, other flow control valves, etc. Also disclosed herein are exemplary methods of making one-piece valve components, e.g., via machining, additive manufacturing (e.g., 3D printing, etc.), other suitable methods for integrally combining conventionally separate internal valve components (e.g., poppet, spring, and retainer, etc.) into a one-piece internal valve component having a unitary, monolithic, and/or single-piece construction, etc.

### CROSS-REFERENCE TO RELATED APPLICATION

This application claims the benefit of and priority to U.S. Provisional Patent Application Ser. No. 63/575,455 filed Apr. 5, 2024. The entire disclosure of this provisional patent application is incorporated herein by reference.

### FIELD

The present disclosure relates to one-piece internal valve components and valves including the same.

### BACKGROUND

This section provides background information related to the present disclosure which is not necessarily prior art.

Conventional check valves, relief valves, and other types of flow control valves rely on a combination of three distinct components, specifically a machined poppet, a coiled compression spring, and a retainer. The retainer is configured to keep the coiled spring compressed against a mechanical seat and fixes the assembly in place through swagged retention. As fluid flows into the device, the pressure applied on the poppet compresses the spring, allowing fluid to flow, divert, stop, etc. See, for example, the conventional valve shown in FIGS. 17-22.

### DRAWINGS

The drawings described herein are for illustrative purposes only of selected embodiments and not all possible implementations and are not intended to limit the scope of the present disclosure.

FIG. 1 shows a one-piece internal valve component (e.g., for a two-piece relief valve, etc.) according to an exemplary embodiment of the present disclosure.

FIGS. 2 and 3 show an exemplary two-piece relief valve (broadly, a valve) including a valve body and the one-piece internal valve component shown in FIG. 1.

FIG. 4 shows the one-piece internal valve component and the valve body of the two-piece relief valve shown in FIGS. 2 and 3. For comparison purposes, FIG. 4 also shows a conventional three-piece internal valve assembly for a four-piece relief valve.

FIG. 5 shows a one-piece internal valve component (e.g., for a two-piece check valve, etc.) according to an exemplary embodiment of the present disclosure.

FIG. 6 shows an exemplary two-piece check valve (broadly, a valve) including a valve body and the one-piece internal valve component shown in FIG. 5.

FIGS. 7, 8, and 9 show the one-piece internal valve component shown in FIGS. 5 and 6. For comparison purposes, FIGS. 7, 8, and 9 also show a conventional three-piece internal valve assembly for a four-piece check valve.

FIG. 10 is an exploded perspective view of a two-piece check valve (broadly, a valve) including a valve body and a one-piece internal valve component according to an exemplary embodiment.

FIG. 11 is a perspective view of the two-piece check valve shown in FIG. 10 after the one-piece internal valve component has been slidably positioned within the valve body.

FIGS. 12 and 13 are respective cross-sectional side and perspective views of the two-piece check valve shown in FIG. 11, wherein the poppet (broadly, valve closure member) of the one-piece internal valve component is seated against a valve seat defined by the valve body, thereby closing the valve and preventing fluid flow through the internal passage of the valve body.

FIGS. 14 and 15 are respective cross-sectional side and perspective views of the two-piece check valve shown in FIGS. 12 and 13, wherein the poppet of the one-piece internal valve component is no longer seated against and is spaced apart from the valve seat, thereby opening the valve and allowing fluid flow through the internal passage of the valve body.

FIG. 16 includes a table of example performance data for a two-piece check valve with an energized poppet of the one-piece internal valve component as shown in FIGS. 6-9.

FIG. 17 shows conventional four-piece valves each including a three-piece internal valve assembly within a valve body. The conventional three-piece internal valve assembly includes a poppet, a spring, and a retainer, which are three distinct components that are separately manufactured and thereafter assembled together.

FIG. 18 is a perspective view of a conventional flow control valve that may be used for controlling the flow of gasses and liquids.

FIG. 19 is an exploded perspective view of the conventional flow control valve shown in FIG. 18, and illustrating its conventional three-piece internal valve assembly. The conventional three-piece internal valve component includes a poppet, a coil spring, and a retainer, which are three distinct components that are separately manufactured and thereafter assembled together.

FIG. 20 is a partial perspective view of the conventional flow control valve shown in FIG. 19 after the various separate components have been assembled together including the poppet, the spring, and the retainer.

FIG. 21 is a perspective view of the conventional flow control valve shown in FIG. 20, wherein the poppet of the three-piece internal valve component is seated against a valve seat defined by the valve body, thereby closing and preventing fluid flow through the internal passage of the valve body.

FIG. 22 is a perspective view of the conventional flow control valve shown in FIG. 21, wherein the poppet of the three-piece internal valve component is no longer seated against and is spaced apart from the valve seat, thereby opening and allowing fluid flow through the internal passage of the valve body.

### DETAILED DESCRIPTION

Example embodiments will now be described more fully with reference to the accompanying drawings.

Conventional check valves, relief valves, and other types of flow control valves rely on a combination of three distinct components, specifically a machined poppet, a coiled compression spring, and a retainer. The retainer is configured to keep the coiled spring compressed against a mechanical seat and fixes the assembly in place through swagged retention. As fluid flows into the device, the pressure applied on the poppet compresses the spring, allowing fluid to flow, divert, stop, etc.

Conventionally, the machined poppet, coiled compression spring, and retainer are manufactured by different manufactures and/or sourced from different suppliers. As disclosed herein, exemplary embodiments of the present disclosure combine all three components into one part (e.g., one machined part, one 3D printed part, etc.).

In exemplary embodiments, a one-piece internal valve component integrally include a combination of conventionally separate components (e.g., poppet (broadly, valve closure member), coil spring (broadly, biasing member), and retainer, etc.) such that the one-piece internal valve component has a unitary, monolithic, and/or single-piece construction. The one-piece internal valve components may be used in various valves, such as two-piece valves, check valves, relief valves, flow control valves for aircraft hydraulic systems, other flow control valves, two-piece aerospace valve, two-piece inline aerospace valve, fluid pressure/flow activated two-piece check valve assembly biased in closed position, fluid pressure/flow activated two-piece relief valve assembly biased in closed position, fluid pressure/flow activated two-piece flow diversion assembly, integrated multifunctional poppet/retainer, integrated multifunctional/multiphysics poppet/spring/retainer, etc. Also disclosed herein are exemplary methods of making one-piece valve components, e.g., via machining, additive manufacturing (e.g., 3D printing, etc.), other suitable methods for integrally combining conventionally separate internal valve components (e.g., poppet, spring, and retainer, etc.) into a one-piece internal valve component having a unitary, monolithic, and/or single-piece construction, etc.

Classic technical literature and papers dating back to the 1960s discuss the features around individual poppets, types of springs, and forms of fixation of these features. The literature expressly centers around each one of these items individually. As disclosed herein, exemplary embodiments have advantageously integrated these conventionally separate distinct components into one single device (e.g., one single machined part, one single 3D printed part, etc.). Integrating the poppet, spring, and retainer (which are conventionally three distinct components that are separately manufactured and must be assembled together) into a one-piece internal valve component may provide one or more (but not necessarily any or all) of the following advantages such as reduced processing time, reduced labor to assemble, reduced inventory and logistics management, enables 3D printing using additive manufacturing methods, and other advantages disclosed herein.

Exemplary embodiments are disclosed in which the poppet, spring, and retainer are integrally formed, combined, and/or included within one integrated piece (e.g., machined, 3D printed using additive manufacturing methods, etc.) having a unitary, monolithic, and/or single-piece construction, structure, or integration. In such exemplary embodiments, all features and functionalities of each of the poppet, spring, and retainer are integrated into a one-piece internal valve component, which is not present in the literature and has not been used in the industry for high-precision metal-to-metal poppet seat check valves in the aerospace industry.

Accordingly, disclosed exemplary embodiments integrate three critical components (the poppet, spring, and retainer) resulting in a one-piece internal valve product. This unified part may be meticulously formed (e.g., via machining 3D printing, additive manufacturing, etc.) to incorporate the multiple features of the traditionally separately manufactured poppet, spring, and retainer. In exemplary embodiments, both ends of the biasing member (e.g., machined spring, etc.) are configured or tailored to have specific functionalities. On end, the biasing member embodies or integrally includes the essential features of a poppet (e.g., an aerospace valve poppet, etc.), while the opposite other end seamlessly integrates the functional aspects of a retainer (e.g., an aerospace valve retainer, etc.). Once assembled within a valve body, the integrated single part forms a cohesive unit for the two-piece valve. The resulting valve assembly, comprising this integrated one-piece (poppet/spring/retainer) internal valve component can be effectively employed in various applications, including relief, check, or other flow diversion, restriction, or shut-off scenarios.

Exemplary embodiments disclosed herein may also offer technical benefits that leverage the physics of the integrated one-piece internal valve components. Integrating a mechanical spring, a retainer, and a poppet into a single integrated (e.g., machined, 3D printed, etc.) part for an aerospace valve improves the physics of the design. As explained below, there are six areas of technical innovation worth exploiting specifically: (1) Harmonic Oscillation Control, Thermal Expansion Compensation, Fluid Dynamics Optimization, Increased Structural Integrity, Precision Machining Tolerance, and Reduced Vibrational Stress.

### Harmonic Oscillation Control

In exemplary embodiments, the unified/unitary design of the one-piece internal valve component allows for better control of harmonic oscillations within the system, thereby reducing the risk of resonance-induced failures. Harmonic oscillation control is a critical aspect of mechanical design, especially in aerospace applications where components are often subjected to various forces and vibrations. Exemplary embodiments disclosed herein may be configured to provide improved harmonic oscillation control as explained below.

Unified Structure: In a conventional valve design, the spring, retainer, and poppet are separate distinct components that are manufactured separately and assembled together. Each interface between these components can introduce potential points of vibration or oscillation. Integrating these three spring, retainer, and poppet components into a single unitary (e.g., machined, 3D printed, integrally formed, etc.) part reduces the number of interfaces, which can help minimize the sources of harmonic oscillation.

Material Consistency: In exemplary embodiments, the integrated one-piece internal valve component or part is integrally formed (e.g., machined, etc.) from a single piece of material thereby providing consistent material properties throughout the single piece of material. This uniformity of the material properties enables predictable and controlled vibrational behavior, which is crucial for managing harmonic oscillations.

Optimized Resonant Frequency: In exemplary embodiments, the design and material choice for the integrated unitary one-piece internal valve component or part are optimized to shift the resonant frequency away from the operational frequency range of the valve. This helps avoid resonance conditions that could otherwise lead to excessive vibrations and potential failure.

Damping Properties: In exemplary embodiments, the single-piece construction of internal valve component or part may also enhance the damping properties of the valve, which can help to dissipate vibrational energy and reduce the amplitude of oscillations.

Reduced Mass: In exemplary embodiments, the integrated design also reduces the overall mass of the valve. A lower mass changes the system's natural frequency, moving it out of the range of frequencies the valve is likely to encounter, thereby reducing the risk of resonance.

The factors listed above (unified structure, material consistency, optimized resonance frequency, damping properties, reduced mass) individually and/or in combination may significantly improve the control of harmonic oscillations, thereby enhancing the reliability and performance of an aerospace valve.

### Thermal Expansion Compensation

The single-piece construction improves the valve's ability to compensate for thermal expansion and contraction, enhancing its performance under varying temperature conditions. Thermal expansion compensation is crucial in designing mechanical components, especially in aerospace applications where components are exposed to a wide range of temperatures. Below are some technical points on how exemplary embodiments disclosed herein may provide improved thermal expansion compensation as explained below.

Uniform Material Properties: In exemplary embodiments, the integrated one-piece internal valve component or part is integrally formed (e.g., machined, etc.) from a single material thereby providing uniform thermal expansion properties throughout the component. This uniformity of the thermal expansion properties enables a more predictable and controlled thermal behavior, which is crucial for managing thermal expansion.

Reduced Thermal Stresses: Different components have different thermal expansion rates in a conventional valve design, which can lead to thermal stresses at the interfaces. Integrating the spring, retainer, and poppet components into a single-piece unitary (e.g., machined, 3D printed, integrally formed, etc.) part reduces the potential for thermal stress, enhancing the valve's durability and reliability.

Optimized Design for Thermal Expansion: In exemplary embodiments, the design of the integrated unitary one-piece internal valve component or part is optimized to accommodate thermal expansion. For example, allowances for expansion are part of the resident nature of the one-piece design, ensuring that the valve continues to function properly across a range of temperatures.

Improved Temperature Resistance: In exemplary embodiments, the single-piece construction enhances the valve's resistance to temperature changes, increasing its lifespan and reliability.

Thermal Gradient Management: In exemplary embodiments, the unified structure helps manage thermal gradients more effectively. This prevents localized overheating or cooling, ensuring the valve operates optimally under various thermal conditions.

### Fluid Dynamics Optimization

In exemplary embodiments, the streamlined design leads to more efficient fluid flow, reducing turbulence and minimizing pressure drops across the valve. Fluid dynamics optimization is a key aspect in the design of valves, especially in aerospace applications where efficiency and performance are critical. Exemplary embodiments disclosed herein may provide improved fluid dynamics optimization as explained below.

Streamlined Flow Paths: The integrated spring, retainer, and poppet design results in more streamlined flow paths within the valve. This reduces turbulence and flow separation, leading to a more efficient fluid flow and minimizing pressure drops across the valve.

Reduced Flow Obstructions: The single-piece construction reduces potential flow obstructions by eliminating interfaces and connections between separate components, enhancing the overall flow efficiency.

Optimized Flow Area: The design of the integrated part is optimized to provide the maximum flow area when the valve is open, which increases the flow rate and the valve's overall performance.

Improved Sealing: The precision manufacturing (e.g., machining, etc.) of the integrated part results in increased potential energy of the mechanical spring, improved flow surfaces between the components, and poppet reduced leakage, thereby improving the overall efficiency of the valve.

Consistent Flow Characteristics: The uniform material properties of the single integrally formed (e.g., machined, etc.) part can result in more consistent flow characteristics, thereby leading to predictable and reliable valve performance.

Reduced Cavitation Risk: The optimized design and improved flow characteristics reduce the risk of cavitation, which can cause significant damage and efficiency loss in valves.

### Increased Structural Integrity

In exemplary embodiments, the one-piece design eliminates the need for joints or connections between components, which are often points of weakness in a structure. Accordingly, exemplary embodiments disclosed herein may provide increased structural integrity and durability.

### Precision Machining Tolerances

In exemplary embodiments, integrally forming (e.g., machining, etc.) all three spring, retainer, and poppet components as a one-piece unitary component achieves more precise tolerances than would separately manufacturing and assembly three distinct spring, retainer, and poppet parts. Accordingly, exemplary embodiments disclosed herein may provide improved performance and reliability.

### Reduced Vibrational Stress

In exemplary embodiments, the integrated design reduces vibrational stress on the valve, thereby potentially increasing its lifespan and reliability. Conventionally, three separate spring, retainer, and poppet components may act as “pinned” and even “loose” connections, thereby increasing system vibration. But exemplary embodiments disclosed herein have a single contiguous configuration that reduces these unwanted vibration nuances associated with conventional three-piece designs.

In exemplary embodiments, integrating the poppet, spring, and retainer (which are conventionally three distinct components that are separately manufactured and must be assembled together) into a one-piece internal valve component may provide one or more (but not necessarily any or all) of the following advantages. For example, manufacturing an energized poppet may be streamlined and simplified, assembly steps may be reduced, reliability may be increased, performance and material efficiency may be improved, and design innovation may be displayed. Part-to-part assembly tolerance variation may be eliminated. Manufacturing and assembly lead time may be improved. Variation of having three separate parts is eliminated. A single piece is coaxially produced without disruption to the native centerline. The conventional three-part centerlines of the spring, retainer, and poppet are merged into one coaxial centerline in the one-piece internal valve component, which merger allows for optimization of spring potential energy by eliminating mechanical friction between two adjacent components, and a two-step assembly of the one-internal valve component into a valve body. The coaxial fabrication of the one-piece internal valve component enables the one-piece internal valve component to be installed, within a valve body, crimped, and then shipped. There is no assembly required for separate spring, retainer, and poppet components. This potential one-step operation opens up avenues for stepped-up production and industrialization in lower-cost applications.

During the development of the one-piece internal valve components disclosed herein, there were challenges with envelope sizing for the integrally formed (e.g., machined, etc.) spring feature. For example, optimizing between size and spring potential energy was maximized and overcome to produce the same results for a one-piece internal valve component as a three-piece spring, retainer, and poppet configuration. As another example, material processing and sequencing with the helical forming (e.g., cutting, etc.) process related to key characteristics: load (lbf)/deflection (in.)/spring rate (lbf/in.)/cycle life requirements.

In some exemplary embodiments, the one-piece internal valve component includes a machined helical feature instead of a conventional compression spring, which was not a known process such as in the aerospace industry. The exemplary embodiments of the one-piece internal valve components disclosed herein may be used in integrated aerospace valves that have an unlimited application potential in fluid logic control, e.g., flow step, flow diversion, flow restriction, etc.

In addition, the inventor(s) hereof recognized unforeseen and/or previously unappreciated benefits for the one-piece internal valve components disclosed herein. For example, a single piece is a coaxially produced integrally formed (e.g., via machining, 3D printing, etc.) element without disruption to the native centerline, which allows for a one-step installation and valve assembly operation. As another example, integrally forming (e.g., machining, 3D printing, etc.) the conventionally separate three components as one part uses less material than manufacturing them separately, leading to cost savings, material efficiency, a lower environmental impact, and reduced waste stock in holding and cut-out. As a further example, time response during compression and release is improved due to the elimination of mechanical friction between two adjacent separate components.

Exemplary embodiments of the one-piece internal valve components disclosed herein may be configured to have more spring energy, more seating compression, longer seating compression as compared to traditional spring, retainer, and poppet multi-piece designs. Exemplary embodiments of the one-piece internal valve components disclosed herein may be configured for military missiles/rockets systems, if effective, disposable.

In addition, eliminating the need to separately assemble the spring to the retainer and poppet also may improve or alleviate safety concern. For example, separate spring installation experiences edge tangle in logistics, kitting, transport, and requires extra labor to untangle. Mitigating these issues leads to spring-first pass yield problems, projectile safety concerns for eyes, and FOD and slippage on the floor.

Exemplary embodiments disclosed herein also enable additive manufacturing (e.g., 3D printing, etc.) as a viable manufacturing process for a one-piece internal valve component. And the 3D printing options will enable plastic flow control for up-and-coming advance air mobility (AAM) applications where cooling motors are required. The additive manufacturing may also provide or enable manufacturability of coolant flow control systems that are lightweight, nimble, and inexpensive.

In exemplary embodiments, a one-piece internal valve component may be integrally formed (e.g., via machining, additive manufacturing, etc.) from various materials. For example, a one-piece internal valve component may be machined from stainless steel, such as 17-4PH H900 stainless steel alloy, etc. Or, for example, a one-piece internal valve component may be 3D printed from a powdered stainless steel formulation, such as a powdered formulation of 17-4PH H900 stainless steel alloy, etc. By way of background, 17-4PH H900 stainless steel alloy is a chromium-nickel-copper precipitation hardening martensitic stainless steel with an addition of niobium.

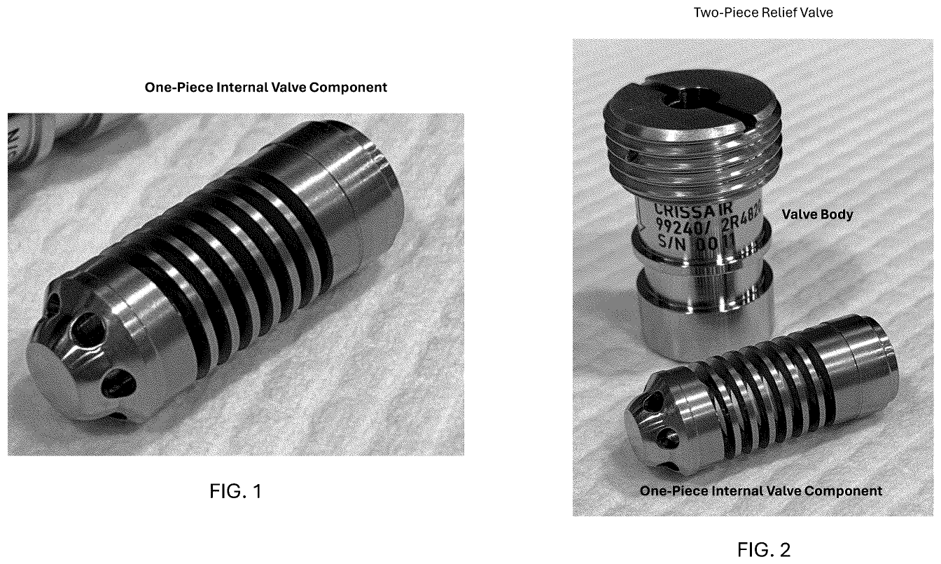

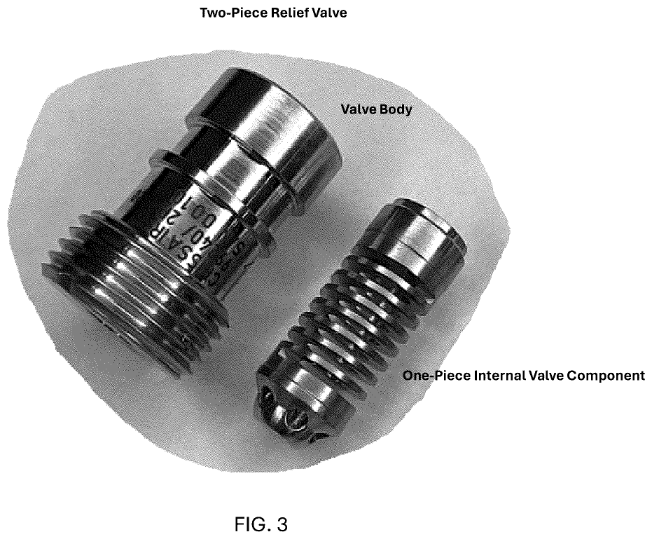

With reference now to the figures, FIG. 1 shows an exemplary embodiment of a one-piece internal valve component (e.g., for a two-piece relief valve, etc.). FIGS. 2 and 3 show an exemplary two-piece relief valve (broadly, a valve) including the one-piece internal valve component shown in FIG. 1. The two-piece relief valve also includes a valve body. The valve body is configured for slidably receiving the one-piece internal valve component.

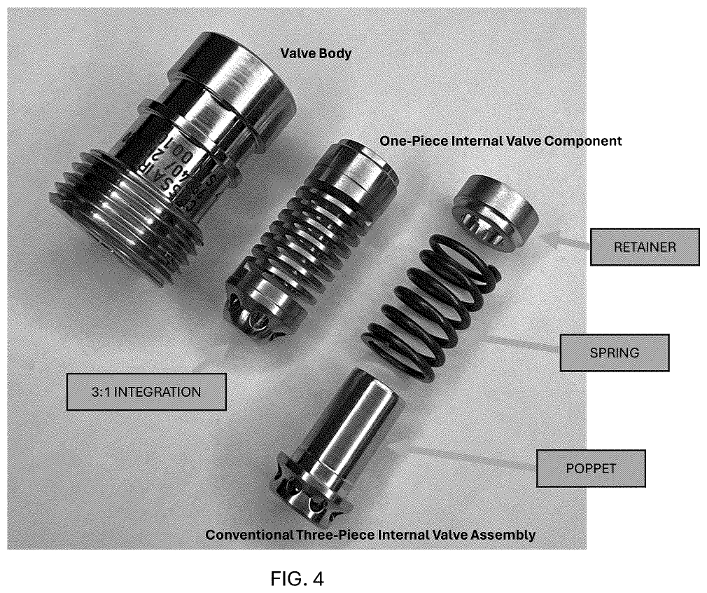

FIG. 4 shows the one-piece internal valve component and the valve body of the two-piece relief valve shown in FIGS. 2 and 3. For comparison purposes, FIG. 4 also shows a conventional three-piece internal valve assembly for a four-piece relief valve. The conventional three-piece internal valve assembly includes a poppet, a spring, and a retainer. In the conventional three-piece internal valve assembly, the poppet, spring, and retainer are three distinct components that are separately manufactured and assembled together.

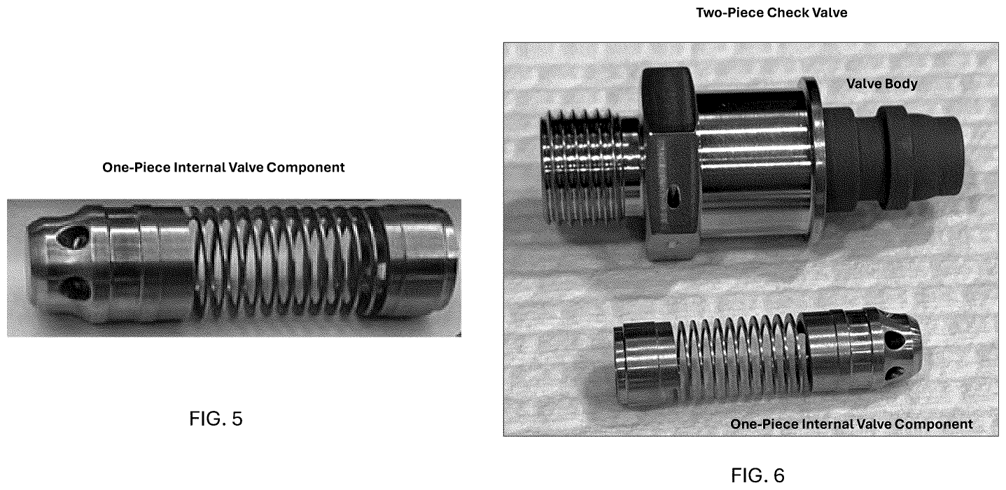

FIG. 5 shows an exemplary embodiment of a one-piece internal valve component (e.g., for a two-piece check valve, etc.). FIG. 6 shows an exemplary two-piece check valve (broadly, a valve) including the one-piece internal valve component shown in FIG. 5. The two-piece check valve also includes a valve body. The valve body is configured for slidably receiving the one-piece internal valve component.

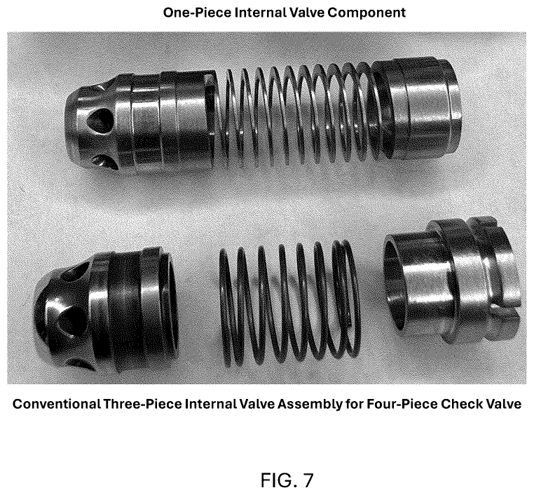

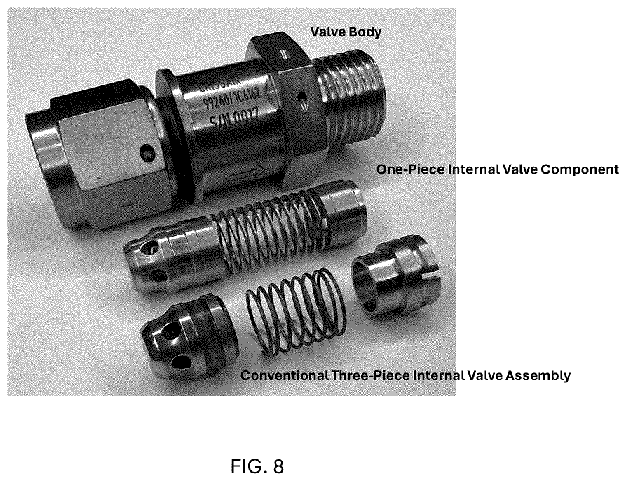

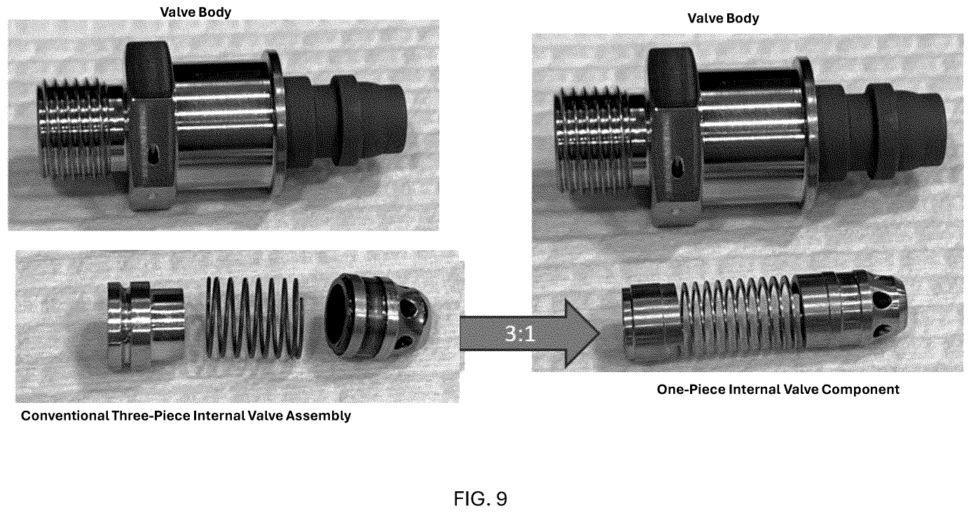

FIGS. 7, 8, and 9 show the one-piece internal valve component shown in FIGS. 5 and 6. For comparison purposes, FIGS. 7, 8, and 9 also show a conventional three-piece internal valve assembly for a four-piece check valve. The conventional three-piece internal valve assembly includes a poppet, a spring, and a retainer. In the conventional three-piece internal valve assembly, the poppet, spring, and retainer are three distinct components that are separately manufactured and assembled together.

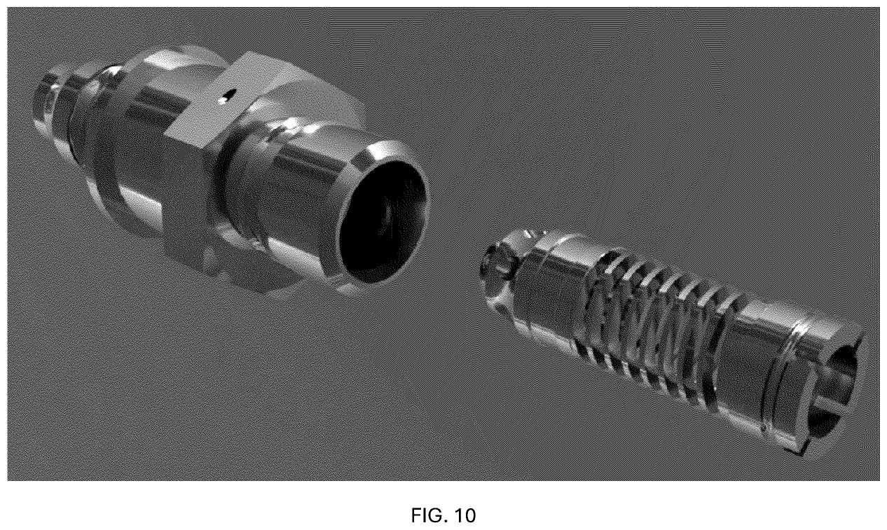

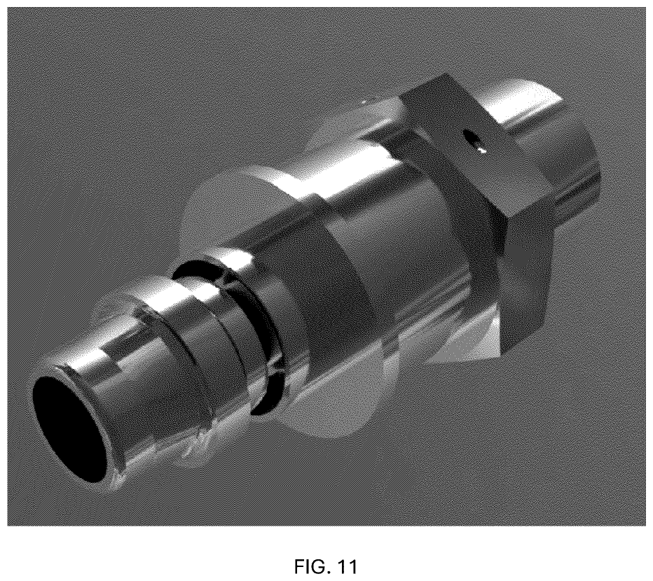

FIG. 10 shows an exemplary embodiment of a two-piece check valve (broadly, a valve) including a one-piece internal valve component and a valve body. As shown in FIG. 10, the one-piece internal valve component is aligned for slidably positioning within the valve body. FIG. 11 shows the two-piece check valve after the one-piece internal valve component has been slidably positioned within the valve body.

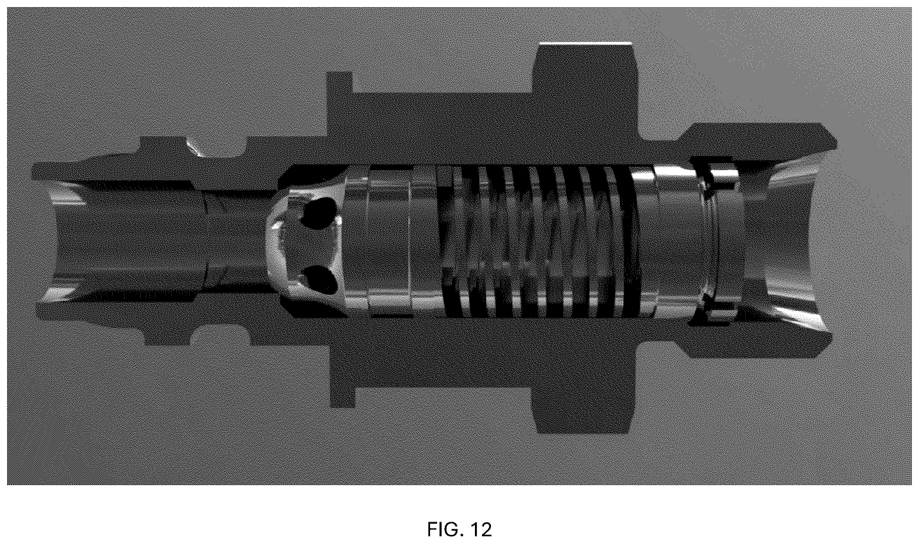

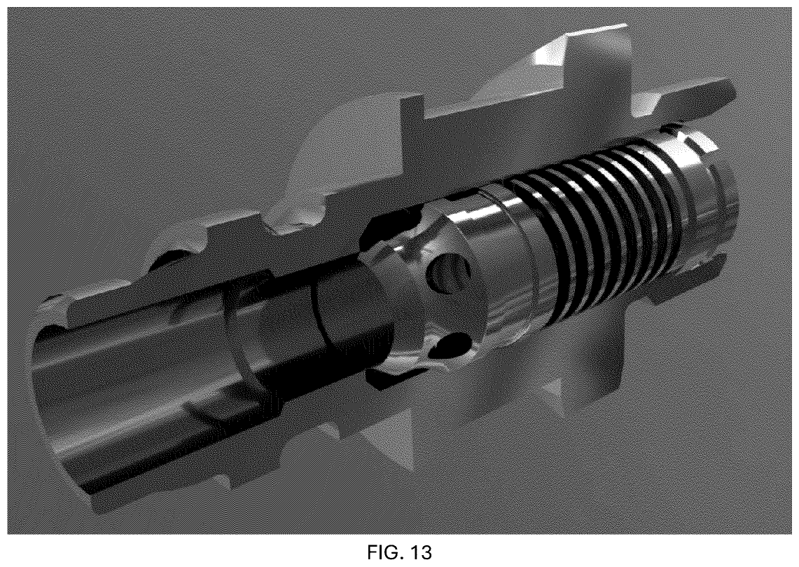

FIGS. 12 and 13 show the two-piece check valve shown in FIG. 11 with the poppet (broadly, valve closure member) of the one-piece internal valve component seated against a valve seat defined by the valve body. Accordingly, the valve is closed as the poppet prevents fluid flow through the internal passage of the valve body. The biasing member (e.g., coiled compression biasing member integrally formed with, etc.) of the one-piece internal valve component is in an extended but partially compressed state such that there are spaces between the coils of the biasing member. The partially compressed biasing member is operable for applying a biasing force between the poppet and the retainer such that the poppet remains seated against the valve seat and biased in the closed position.

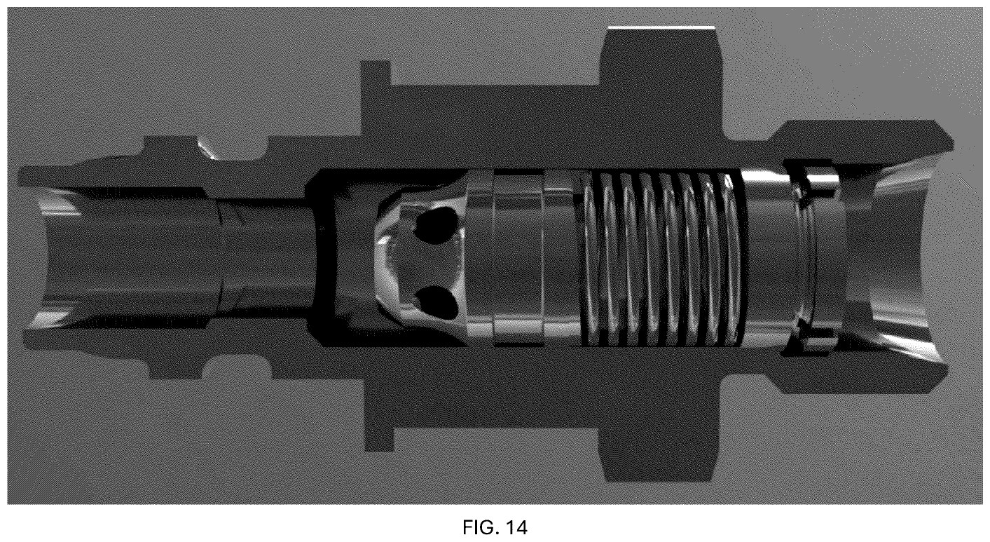

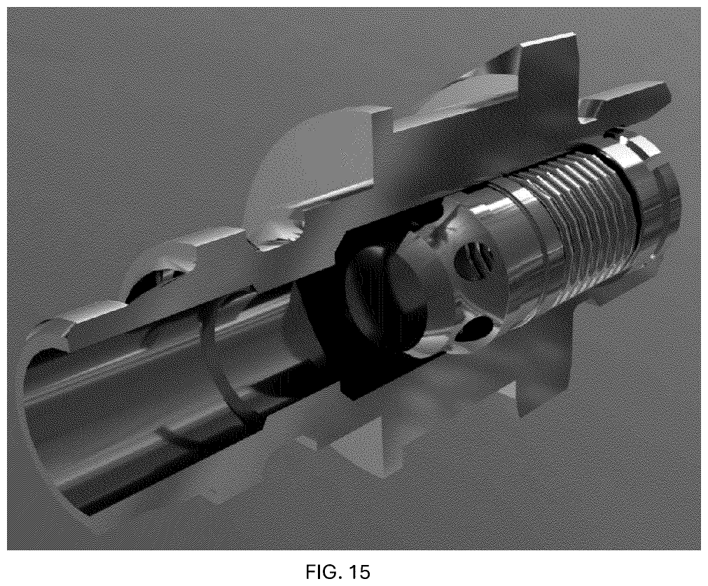

FIGS. 14 and 15 shown the two-piece check valve shown in FIGS. 12 and 13 but after the poppet of the one-piece internal valve component is no longer seated against and spaced apart from the valve seat. Accordingly, the valve is open and fluid flow is allowed through the internal passage of the valve body. The biasing member of the one-piece internal valve component is in a more compressed state such that the coils have become shorter and the spaces between the coils of the biasing member has been reduced. The compression and shortening of the coils moves the poppet away from the valve seat. This occurs as fluid flows into the valve and the pressure applied on the poppet compresses the biasing member.

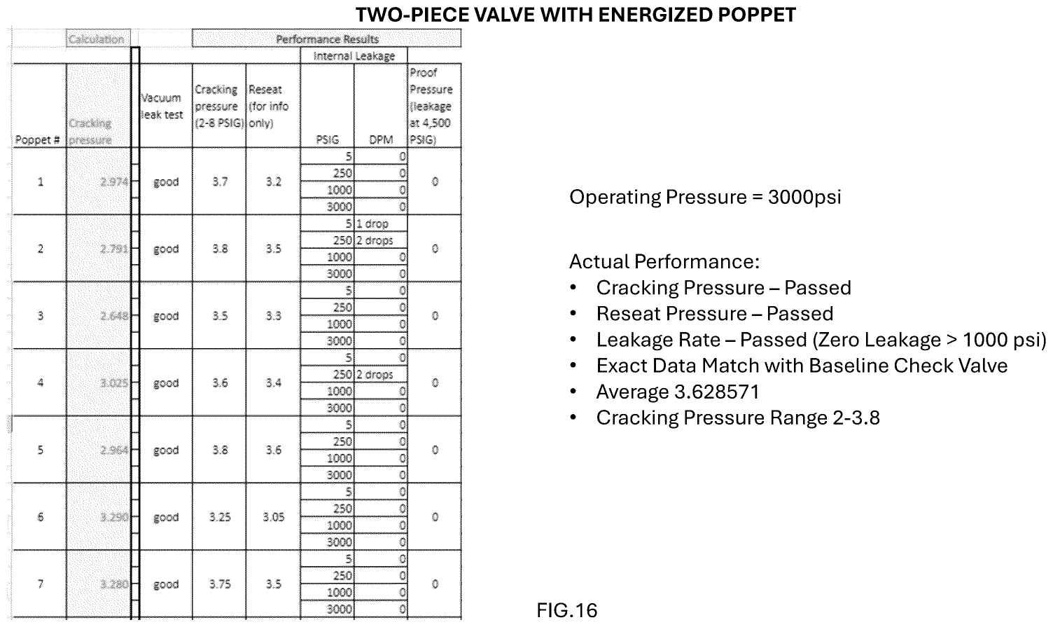

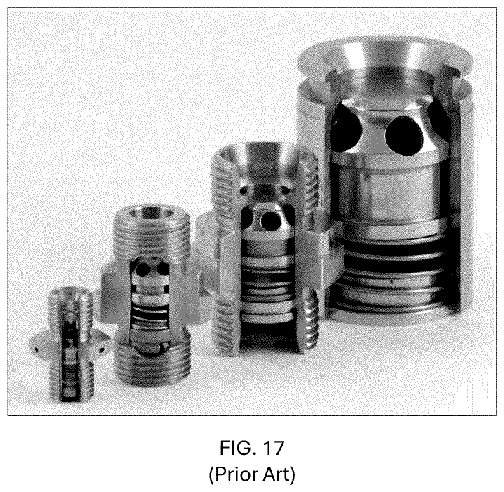

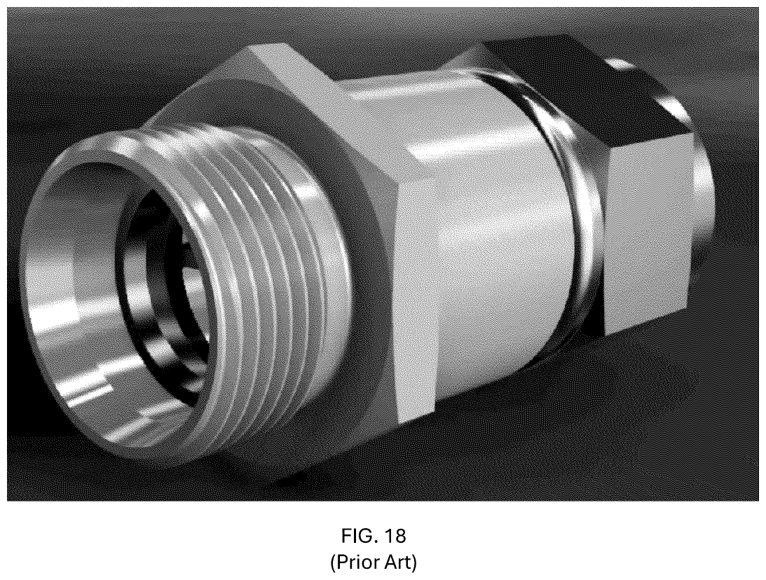

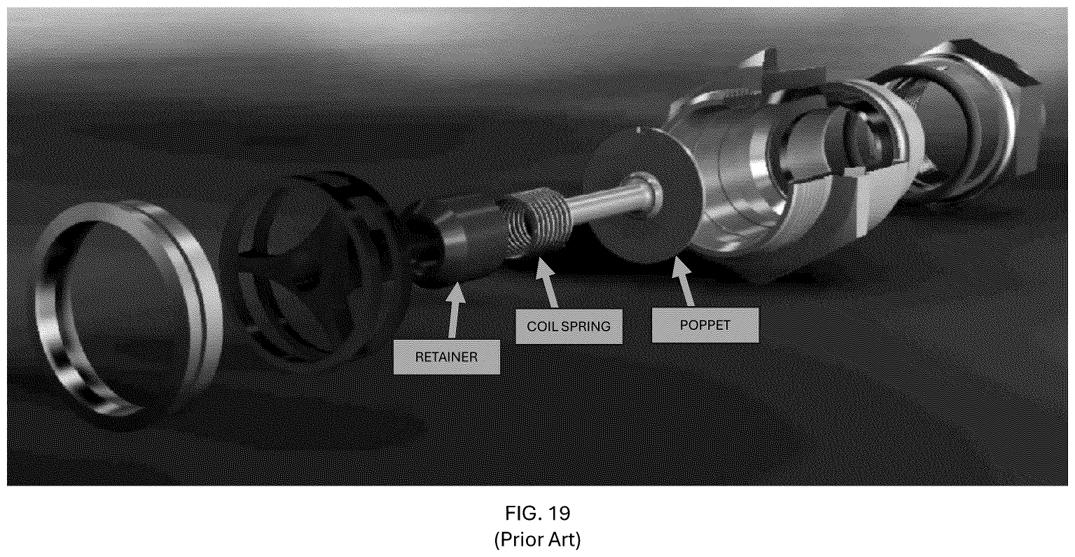

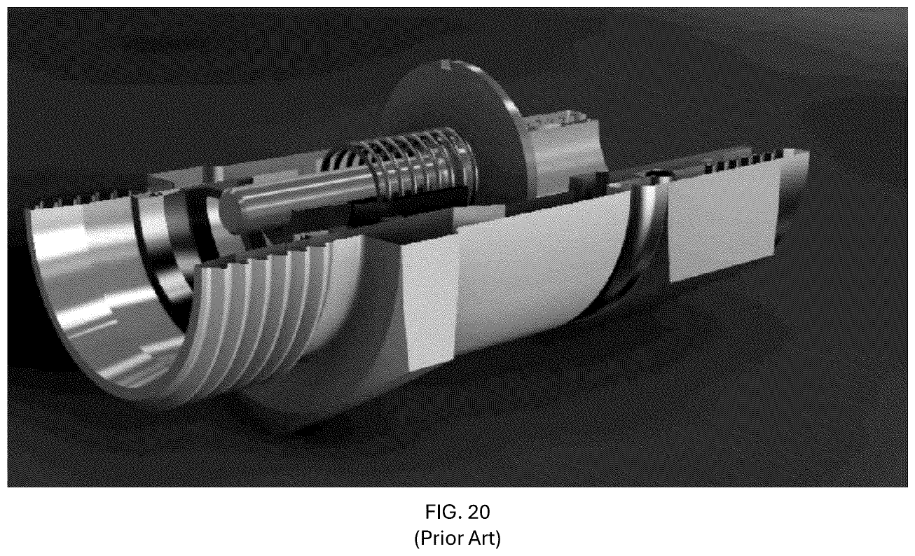

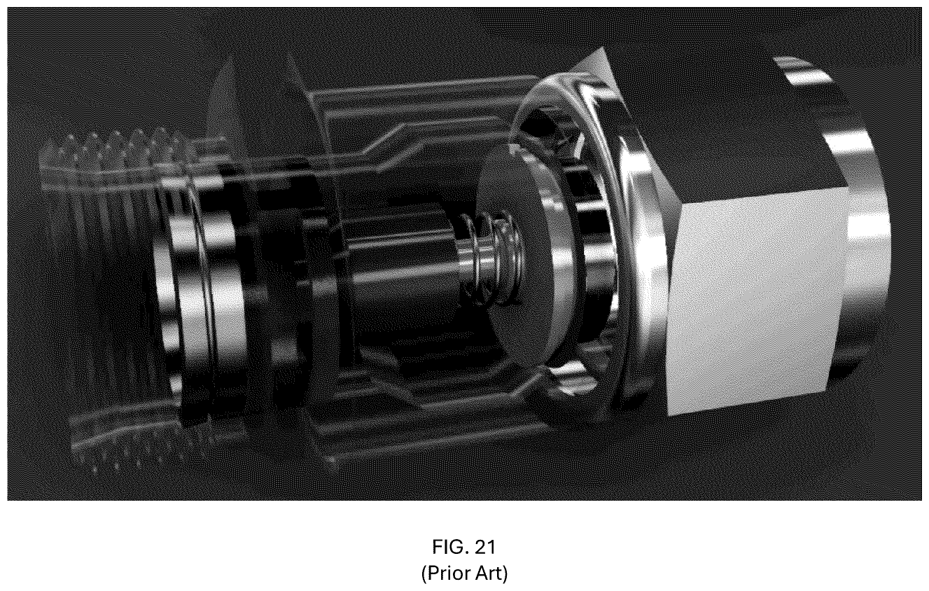

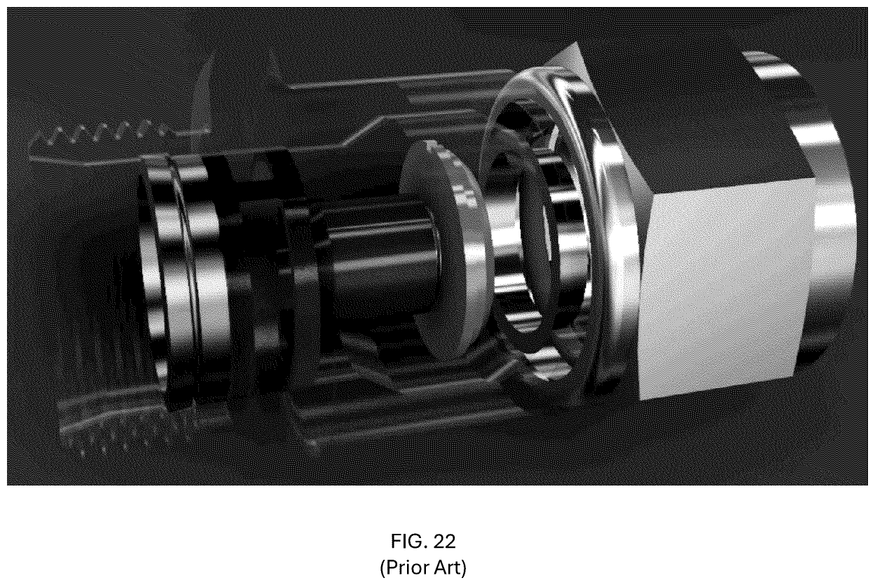

FIG. 16 includes a table of example performance data for a two-piece check valve with an energized poppet of the one-piece internal valve component as shown in FIGS. 6-9. Generally, FIG. 16 shows that the actual performance of the two-piece check valve with the one-piece internal valve component at an operating pressure of 3000 PSI had passing marks for cracking pressure, reseat pressure, and leakage rate. For example, the two-piece check valve with the energized poppet of the one-piece internal valve component had a zero leakage at greater than 1000 PSI, had data matching with a conventional baseline four-piece check valve, had an average cracking pressure of about 3.63 PSIG, and a cracking pressure range from 3.25 to 3.8 PSIG.

With further regard for the energized poppet of the one-piece internal valve component shown in FIGS. 6-9, inherent spring energy is stored in its mechanically integrated compression spring (broadly, biasing member) and its fixed base integrated retainer. For this all-in-one internal valve component, the poppet, spring, and retainer are combined into one part thereby combing or integrating three distinct parts that conventionally have been separately manufactured and thereafter assembled together.

In exemplary embodiments, the energized poppet is preferably configured to include a precisely calibrated spring with accurate force tolerances, acting as a force element in pressure valves. Combined with this force element is the seating and sealing of the poppet. The poppet integrated with spring properties acts with compressive forces. The force exerted on the poppet from fluid flow acts like a compression spring and is linearly proportional to its displacement. This is ideal for applications requiring resistance to compressive loads leading to fluid control.

In addition, metal-to-metal seat poppet valves for aerospace applications require zero leak rates at rated pressures. As shown in FIG. 16, the device or valve with an energized poppet of the one-piece internal valve component as shown in FIGS. 6-9. achieved zero leak rate at rated operating pressures. This achievement of zero leak rate is due to the integrated poppet spring energy through compression and force delivery with the supported integrated fixed retention.

The combined integrated properties of the energized poppet creates a system with potential energy. The poppet has the ability to absorb and store potential energy, which is why the poppet is also referred to herein as an energized poppet. Exemplary embodiments disclosed herein may provide practical benefits in terms of integration, simplified manufacturing, and efficient assembly. All the physics and functions of three individual components (poppet, spring, and retainer) are seamlessly integrated into a one-piece internal valve component. By consolidating these three individual components, manufacturing becomes more straightforward, resulting in cost reduction, streamlined logistics, and improved lead-time. And the assembly process is expedited because the energized poppet can be easily installed and crimped, yielding a completed assembly.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A one-piece valve component comprising:
a valve closure member configured to be movable relative to a valve seat within a valve body including:
a closed position in which the valve closure member is seated against a valve seat within the valve body and prevents fluid flow through an internal passage of the valve body; and
an open position in which the valve closure member is spaced apart from the valve seat and allows fluid flow through the internal passage of the valve body;
a biasing member configured to be operable for biasing the valve closure member relative to the valve seat; and
a retainer configured to be operable for retaining the one-piece valve component in place within the valve body;
wherein the valve closure member, the biasing member, and the retainer are integrated and/or integrally defined by the one-piece valve component such that the one-piece valve component has a unitary, monolithic, and/or single-piece construction.

2. The one-piece valve component of claim 1, wherein the valve closure member and the retainer are integrally formed with the biasing member at respective opposite first and second end portions of the biasing member.

3. The one-piece valve component of claim 1, wherein the valve closure member, the biasing member, and the retainer are integrally formed from a single piece of material.

4. The one-piece valve component of claim 1, wherein the valve closure member, the biasing member, and the retainer are integrally formed from stainless steel.

5. The one-piece valve component of claim 1, wherein the one-piece valve component is configured such that the retainer is operable for retaining the biasing member in a compressed condition in which the valve closure member is seated against the valve seat in a biased closed position.

6. The one-piece valve component of claim 1, wherein the valve closure member, the biasing member, and the retainer are integrally machined from a single piece of material.

7. The one-piece valve component of claim 1, wherein the valve closure member, the biasing member, and the retainer are integrally formed with each other via an additive manufacturing process.

8. The one-piece valve component of claim 1, wherein the valve closure member comprises a poppet, and the biasing member comprises a helical spring member, and wherein:
the poppet and the retainer are integrally formed with the helical spring member at respective opposite first and second end portions of the helical spring member; and/or
the one-piece valve component integrally includes a combination of the poppet, the retainer, and the helical spring member such that the one-piece valve component has a unitary, monolithic, and single-piece construction.

9. The one-piece valve component of claim 1, wherein the integration of the valve closure member, the biasing member, and the retainer into the one-piece valve component provides or enables one or more of the following as compared to a conventional three-piece poppet, spring, retainer valve assembly:
improved control of harmonic oscillations within a system including the one-piece valve component;
improved thermal expansion compensation;
improved fluid dynamics optimization;
increased structural integrity;
improved and/or precision machining tolerance; and
reduced vibrational stress.

10. The one-piece valve component of claim 1, wherein the valve closure member, the biasing member, and the retainer are configured to be operable as an energized poppet that provides a system with potential energy having the ability to absorb and store potential energy.

11. The one-piece valve component of claim 1, wherein the valve closure member, the biasing member, and the retainer are configured to be operable as an energized poppet configured to include a precisely calibrated spring with accurate force tolerances, whereby the energized poppet is operable as force element in a pressure valve, with spring properties acting with compressive forces, and with the force exerted on the energized poppet from fluid flow acting like a compression spring and linearly proportional to its displacement.

12. The one-piece valve component of claim 1, wherein the integration of the valve closure member, the biasing member, and the retainer into the one-piece valve component provides a single coaxial centerline collectively defined for the valve closure member, the biasing member, and the retainer and eliminates mechanical friction between adjacent portions of the valve closure member, the biasing member, and the retainer.

13. A valve comprising a valve body and the one-piece valve component of claim 1 within the valve body.

14. The valve of claim 13, wherein:
the valve body defines a metal seat;
the valve closure member comprises a metal aerospace valve poppet; and
the valve comprises a high-precision metal-to-metal poppet seat check valve suitable for use as an aerospace valve, a flow control valve for an aircraft hydraulic system, and/or a metal-to-metal seat poppet valves for aerospace applications requiring zero leak rates at rated pressures.

15. The valve of claim 13, wherein:
the valve consists of the valve body and the one-piece valve component such that the valve is a two-piece valve; and/or
the valve comprises a flow control valve configured to be usable for controlling flow of hydraulic fluid in an aircraft hydraulic system.

16. The valve of claim 13, wherein the valve comprises one or more of:
a check valve;
a relief valve;
a flow control valve for an aircraft hydraulic system;
a two-piece aerospace valve;
a two-piece inline aerospace valve;
a fluid pressure/flow activated two-piece check valve assembly biased in the closed position;
a fluid pressure/flow activated two-piece relief valve assembly biased in a closed position; and/or
a fluid pressure/flow activated two-piece flow diversion assembly.

17. A method comprising integrating a valve closure member, a biasing member, and a retainer into a one-piece valve component such that the one-piece valve component has a unitary, monolithic, and/or single-piece construction.

18. The method of claim 17, wherein integrating the valve closure member, the biasing member, and the retainer into the one-piece valve component comprises:
machining the valve closure member, the biasing member, and the retainer of the one-piece valve component, such that the one-piece valve component has a unitary, monolithic, and single-piece machined construction; or
3D printing the valve closure member, the biasing member, and the retainer of the one-piece valve component, such that the one-piece valve component has a unitary, monolithic, and single-piece 3D printed construction.

19. A method of assembling a one-piece valve component within a valve body of a valve, the one-piece valve component integrally including a combination of a valve enclosure member, a biasing member, and a retainer, the method comprising installing the one-piece valve component as a single unit within the valve body without having to pre-assemble any of the valve closure member, the biasing member, and the retainer to each other.

20. The method of claim 19, wherein the method further including a crimping process to thereby provide a completed valve assembly including the one-piece valve component and the valve body via a two-step process of (1) installing the one-piece valve component as a single unit within the valve body and (2) the crimping process.
